(19) United States
(12) Patent Application Publication
(10) Pub. No.: US 2012/0301754 A1
(43) Pub. Date: Nov. 29, 2012

(54) Exothermic Reactive Portions Positioned About A Thermal Battery For Increasing an Active Life of the Thermal Battery

(75) Inventor: Jahangir S. Rastegar, Stony Brook, NY (US)

(73) Assignee: Omnitek Partners LLC, Ronkonkoma, NY (US)

(21) Appl. No.: 13/306,959

(22) Filed: Nov. 29, 2011

Related U.S. Application Data
(63) Continuation-in-part of application No. 12/955,875, filed on Nov. 29, 2010.

(51) Int. Cl. H01M 10/48

(52) U.S. Cl. 429/52; 429/90

(57) ABSTRACT

A thermal battery including: a casing; a thermal battery cell disposed in the casing and operatively connected to electrical connections exposed from the casing; at least one portion of a material having an exothermic reaction positioned between the casing and the thermal battery cell; a first initiator for initiating the thermal battery cell; at least one second initiator for initiating the at least one portion; and a temperature sensor for monitoring a temperature of the thermal battery cell corresponding to the at least one portion; wherein the second initiator initiates the at least one portion when the temperature of the thermal battery cell corresponding to the at least one portion falls below a predetermined level.

### CROSS-REFERENCE TO RELATED APPLICATIONS

This application is a Continuation-In-Part of U.S. application Ser. No. 12/955,875 filed on Nov. 29, 2010, the entire contents of which is incorporated herein by reference.

### BACKGROUND

1. Field of the Invention

The present disclosure relates generally to components of thermal batteries, and more particularly to multi-functional insulating and heat generating materials for thermal batteries and the like.

2. Prior Art

Thermal batteries represent a class of reserve batteries that operate at high temperatures. Unlike liquid reserve batteries, in thermal batteries the electrolyte is already in the cells and therefore does not require a distribution mechanism such as spinning. The electrolyte is dry, solid and non-conductive, thereby leaving the battery in a non-operational and inert condition. These batteries incorporate pyrotechnic heat sources to melt the electrolyte just prior to use in order to make them electrically conductive and thereby making the battery active. The most common internal pyrotechnic is a blend of Fe and KClO₄. Thermal batteries utilize a molten salt to serve as the electrolyte upon activation. The electrolytes are usually mixtures of alkali-halide salts and are used with the Li(Si)/FeS₂ or Li(Si)/CoS₂ couples. Some batteries also employ anodes of Li(Al) in place of the Li(Si) anodes. Reserve batteries are inactive and inert when manufactured and become active and begin to produce power only when they are activated.

Thermal batteries have long been used in munitions and other similar applications to provide a relatively large amount of power during a relatively short period of time, mainly during the munitions flight. Thermal batteries have high power density and can provide a large amount of power as long as the electrolyte of the thermal battery stays liquid, thereby conductive. The process of manufacturing thermal batteries is highly labor intensive and requires relatively expensive facilities. Fabrication usually involves costly batch processes, including pressing electrodes and electrolytes into rigid wafers, and assembling batteries by hand. The batteries are encased in a hermetically-sealed metal container that is usually cylindrical in shape. Thermal batteries, however, have the advantage of very long shelf life of up to 20 years that is required for munitions applications.

Thermal batteries generally use some type of igniter to provide a controlled pyrotechnic reaction to produce output flame or hot particles to ignite the heating elements of the thermal battery. There are currently two distinct classes of igniters that are available for use in thermal batteries. The first class of igniters operate based on electrical energy. Such electrical igniters, however, require electrical energy, thereby requiring an onboard battery or other power sources with related shelf life and/or complexity and volume requirements to operate and initiate the thermal battery. The second class of igniters, commonly called “inertial igniters,” operate based on the firing acceleration. The inertial igniters do not require onboard batteries for their operation and are thereby often used in high-G munitions applications such as in non-spinning gun-fired munitions and mortars.

In general, the inertial igniters, particularly those that are designed to operate at relatively low impact levels, have to be provided with the means for distinguishing events such as accidental drops or explosions in their vicinity from the firing acceleration levels above which they are designed to be activated.

Insulation and internal heat sinks are used to maintain the electrolyte in its molten and conductive condition during the time of use following their activation. The length of time that the electrolyte stays molten determines the active life of the battery. To increase the active life, the amount of available heat energy needs to be increased and/or more effective insulation material needs to be provided. For smaller size thermal batteries, the volume of the insulation material that can be provided becomes limited. In addition, since the ratio of the surface area to the enclosed molten material volume increases as the battery volume is decreased, the effectiveness of the insulation material decreases as the size of the thermal battery decreases.

The following is a brief description of the thermal battery disclosed in U.S. Pat. No. 3,898,101 “Thermal Battery” by D. M. Bush, et al. However, it must be noted that this selection is for purposes of illustration only and is used for describing similar components with respect to the various embodiments disclosed herein.

As it is shown in the schematic of FIG. 1, reproduced from U.S. Pat. No. 3,898,101, the thermal battery may include a plurality of electrochemical cells 10 stacked one upon the other in electrical series within a suitable casing 12 and thermal insulating barrier 14. Electrical connections may be made in an appropriate manner by suitable electrical leads and terminals 16, 17, and 18 to the respective positive and negative terminals of the upper and lower battery cells in the stack. The heat or thermal generating elements for the battery, which are generally positioned as a part of each battery cell with or without additional heat generating elements at each end of the battery, may be ignited to activate the battery by a suitable electrical match or detonator 20 and heat powder or fuse 22 which is coupled between the match 20 and the heating generating elements in each cell. The battery is normally formed by first stacking the individual cell elements to form separate cells and then the cells stacked together in the form shown in FIG. 1 and placed within the casing 12 and insulator 14 under suitable pressure, such as by a compression force applied by a bolt 23 passing through the center of the cells, or other suitable mechanisms. The so stacked battery cells may then be covered with an end insulator 24 and a casing cover 25 in an appropriate manner. The battery is operated by initiating the electrical match 20 and in turn the heat powder 22 and the individual heat generating elements of the cell stack and the electrical current drawn off through leads 16, 17, and 18.

A need therefore exists for methods and materials that can be used to keep thermal batteries in general and small thermal batteries in particular operational longer following activation. For those applications in which the operational life of the thermal battery following activation is not an issue, such methods and material can be used to reduce the insulation volume requirement, thereby allowing the size of the thermal battery to be reduced. The material used for thermal insulation must also be electrically non-conducting.

### SUMMARY

Accordingly, a method of producing power from a thermal battery is provided. The method comprising: initiating a core of the thermal battery; and initiating at least one portion of a material having an exothermic reaction positioned outside the core when a temperature of at least a portion of the core falls below a predetermined level.

The initiating of the at least one portion can comprise monitoring the temperature of the core corresponding to the at least one portion. The monitoring can comprise determining the temperature of the core based on an output of a sensor. The monitoring can comprise determining the temperature of the core based on an output of the thermal battery.

The at least one portion can comprise a plurality of portions. The initiating of the plurality of portions can comprise monitoring the temperature of the core corresponding to each of the plurality of portions, wherein only those portions of the plurality of portions in which the corresponding core has a temperature determined to be below the predetermined level are initiated.

The predetermined temperature can be an inactivation temperature of the thermal battery.

The product of the exothermic reaction of the at least one portion can be a thermal insulator.

Also provided is a method of producing power from a thermal battery, where the method comprises: initiating a core of the thermal battery; positioning at least one portion of a material having an exothermic reaction positioned outside the core; monitoring a temperature of the core corresponding to the at least one portion; and initiating the at least one portion when the temperature of the core corresponding to the at least one portion falls below a predetermined level.

The positioning of the at least one portion can comprise positioning a plurality of portions of the material having an exothermic reaction positioned outside the core. The monitoring can comprise monitoring the temperature of the core corresponding to each of the plurality of portions, wherein only those portions of the plurality of portions in which the corresponding core has a temperature determined to be below the predetermined level are initiated. The positioning of the plurality of portions can be based on a thermal modeling of the thermal battery.

The predetermined temperature can be an inactivation temperature of the thermal battery.

The monitoring can comprise determining the temperature of the core based on an output of a sensor. The monitoring and initiating of the at least one portion can be provided by an initiation device.

The monitoring can comprise determining the temperature of the core based on an output of the thermal battery.

The product of the exothermic reaction of the at least one portion can be a thermal insulator.

Still further provided is a thermal battery comprising: a casing; a thermal battery cell disposed in the casing and operatively connected to electrical connections exposed from the casing; at least one portion of a material having an exothermic reaction positioned between the casing and the thermal battery cell; a first initiator for initiating the thermal battery cell; at least one second initiator for initiating the at least one portion; and a temperature sensor for monitoring a temperature of the thermal battery cell corresponding to the at least one portion; wherein the second initiator initiates the at least one portion when the temperature of the thermal battery cell corresponding to the at least one portion falls below a predetermined level.

The at least one portion can comprise a fuel and oxidizer mixture. The fuel and oxidizer mixture can comprise silicon nanosponge particles and porous silicon particles.

The thermal battery cell can be selected from a list consisting of perchlorates, nitrates, permanganates, fluorinated polymers and metal oxides

The at least one portion can comprise a plurality of portions of the material having an exothermic reaction positioned between the casing and the thermal battery cell. The temperature sensor can comprise a plurality of temperature sensors, each corresponding to one of the plurality of portions, wherein only those portions of the plurality of portions in which the corresponding thermal battery cell has a temperature determined to be below the predetermined level are initiated.

The temperature sensor can comprise the at least one second initiator.

The thermal battery can further comprise insulator portions disposed between the plurality of portions.

The casing can be cylindrical.

The plurality of portions can be distributed in a pattern based on a computer simulation of the thermal battery cell.

The product of the exothermic reaction of the at least one portion can be a thermal insulator.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a schematic of a cross-section of a thermal battery and igniter assembly of the prior art.

FIG. 2 illustrates a schematic of a first embodiment of a thermal battery.

FIG. 3 illustrates a close-up view of the casing and insulation section of the thermal battery shown in FIG. 2.

FIG. 4 illustrates a close-up view of the casing and insulation sections of a second embodiment of a thermal battery.

FIG. 5 illustrates a close-up view of the casing and insulation sections of a third embodiment of a thermal battery.

FIG. 6 illustrates a close-up view of the casing and insulation sections of a fourth embodiment of a thermal battery.

FIG. 7 illustrates a schematic of a fifth embodiment of a thermal battery.

FIG. 8 illustrates a variation of the thermal battery of FIG. 7.

### DETAILED DESCRIPTION

An embodiment of a thermal battery includes a mixture of fuel(s) and oxidizer(s) which exhibits an exothermic reaction upon initiation, generating heat to prolong the battery operation and where the reaction product (including any residual fuel) is one that can provide thermal insulation. Preferred fuels for the aforementioned multi-functional insulation material are silicon nanosponge particles and porous silicon particles as described in U.S. Pat. Nos. 7,560,085 and 756,920, the contents of which are incorporated herein by reference. Silicon nanosponge particles are prepared from a metallurgical grade silicon powder having an initial particle size ranging from about 1 micron to about 4 microns. Each silicon nanosponge particle has a structure comprising a plurality of nanocrystals with pores disposed between the nanocrystals and throughout the entire nanosponge particle. Porous silicon particles having a particle size >0.5 micron are also prepared from a metallurgical grade silicon powder but comprise a solid core surrounded by a porous silicon layer having a thickness greater than about 0.5 microns. The silicon nanosponge and porous silicon particles together with appropriate oxidizers can be formulated to burn at a desired rate and to form the chemical compound silicon dioxide, SiO₂, also known as silica. Silica has very high thermal insulation and electrical insulation characteristics. By using the proper type and amount of oxidizers, the amount of gasses that can be generated during the process of burning of the silicon nanosponge material is minimized. The Table shows the expected reaction of silicon with various oxidizers and the estimated heat of reaction. Oxidizers including but not limited to perchlorates, nitrates, permanganates, fluorinated polymers and metal oxides can be used. The oxidizer may be chosen based on the desired burn rate and ignition characteristics. The Brunauer.Emmet.Teller (B.E.T.) surface area of the silicon nanosponge and porous silicon particles can also be changed as described in U.S. Pat. No. 7,560,085, the contents of which are also incorporated herein by reference. The burn rate and heat output can also be controlled by varying the particle size, surface area and porosity of the porous silicon particles. Hereinafter, the silicon nanosponge materials and the porous silicon particles together (“treated”) with the appropriate oxidizers are referred to as the “porous silicon-based pyrotechnic” material.

It will be appreciated by those of ordinary skill in the art that the relative amount of oxidizer used may be selected to oxidize (burn) a desired portion of the silicon nanosponge or porous silicon particle to generate the desired amount of heat per unit volume of the aforementioned “porous silicon-based pyrotechnic” material used in the thermal battery and/or to control (minimize) the amount of gasses that the oxidization process could generate.

TABLE
Summary of reactions of Silicon with various oxidizers and
the theoretical heat of reaction per unit mass and unit volume

| | □Hr (kJ/g) | □Hr (kJ/cc) |
|---|---|---|
| Reaction | (Si + oxidizer) | (Si + oxidizer) |
| Si + O₂ → SiO₂ | −15.2 | −4.5 |
| 2Si + NaClO₄ → 2SiO₂ + NaCl | −10.4 | −16 |
| 2Si + KClO₄ → 2SiO₂ + KCl | −9.4 | −18 |
| 5Si + 4KNO₃ → 5SiO₂ + 2N₂ + 2K₂O | −6.1 | −10 |
| Si + (C₂F₄)ₙ → SiF₄ + 2C | −6.2 | −12 |
| Si + 2CuO → SiO₂ + 2Cu | −3.0 | −12 |
| 3Si + 2Bi₂O₃ → 4Bi + 3SiO₂ | −1.4 | −8.5 |

It is noted that the silicon nanosponge materials and porous silicon particles as well as silica have very high thermal insulation (very low thermal conductivity) characteristics and are therefore good candidates for use as thermal barriers in thermal batteries. In addition, when necessary, particularly for the ease of manufacturing, the silicon particles may be used with appropriate binders to allow them to be formed or molded into the desired shape for use in thermal batteries. However, the molding method should preserve the porosity and surface area of the materials in order to maintain the oxidation characteristics. In general, binders that generate minimal amount of gas when heated to the thermal battery activation temperatures are highly desirable since such gasses can degrade the performance of the thermal battery.

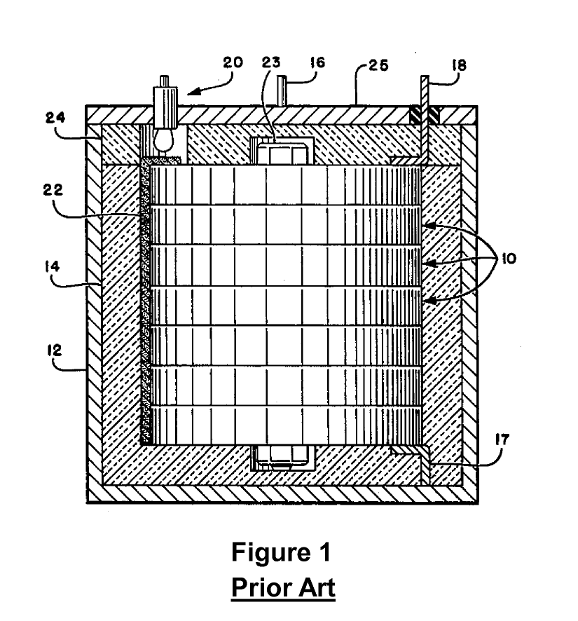

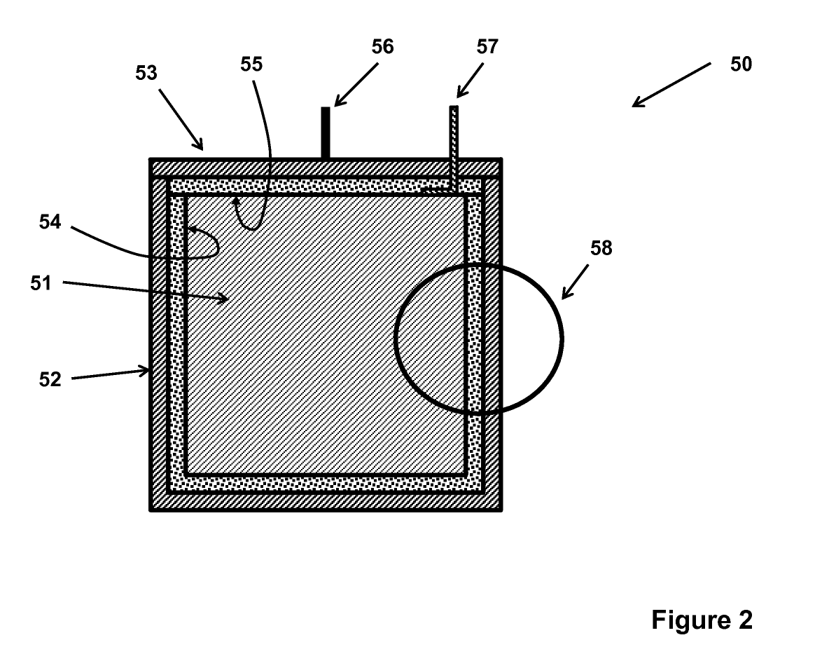

As discussed above, currently available thermal batteries have various electrochemical cell and other internal component and initiation designs. Almost all thermal batteries, however, generally use the insulation materials to enclose the hot interior of the thermal batteries (items 14 and 24 in FIG. 1) and provide a thermal insulating barrier to keep the battery operational for the required length of time. Hereinafter and for the sake of describing the various embodiments disclosed below, the hot interior elements of thermal batteries and the initiation device 20 (excluding the insulating thermal barriers 14 and 24 and the outside shell 12 and the cap 25—FIG. 1) are represented as a single interior element 51 as shown in the schematic of the first embodiment 50 illustrated in FIG. 2.

In the schematic of the first embodiment 50 illustrated in FIG. 2, the aforementioned interior element 51 is enclosed within an appropriate casing 52 and cover 53, usually stainless steel and hermetically sealed. The space between the interior element 51 and the casing 52 and cover 53 is filled with the aforementioned “porous silicon-based pyrotechnic” material 54 and 55, respectively. The thermal battery leads are indicated by numerals 56 and 57.

It will be appreciated by those skilled in the art that any portion of the volume 54 and 55 that is filled with the aforementioned “porous silicon-based pyrotechnic” may instead be filled with any other commonly used (usually organic) insulation material. This might be particularly elected to be done for the cover region 55 where the battery leads 56 and 57 are located.

In operation, once the thermal battery is activated by igniting the heat generating elements of the thermal battery inside the element 51, FIG. 2, the “porous silicon-based pyrotechnic” material 54 and 55 are also ignited as the consequence of the thermal battery activation via the heat generating elements of the battery or via separately provided pyrotechnic elements (not shown). Once the “porous silicon-based pyrotechnic” material 54 and 55 are ignited, as a result of at least partial silicon sponge material burning (oxidation), at least a portion of the silicon sponge material is converted to silica. As a result, firstly, heat is generated, which would have the beneficial effect of keeping the thermal battery operational longer or at least require lesser amounts of heat generating elements, thereby allowing the construction of relatively smaller thermal batteries that would stay operational the same length of time. Secondly, the conversion of the already substantially thermally insulating silicon sponge material to silica would generally increase its thermally insulating characteristics. As a result, the burning of the “porous silicon-based pyrotechnic” material 54 and 55 has the substantial effect of turning it into an effective thermal barrier while initially providing heat to the thermal battery core 51.

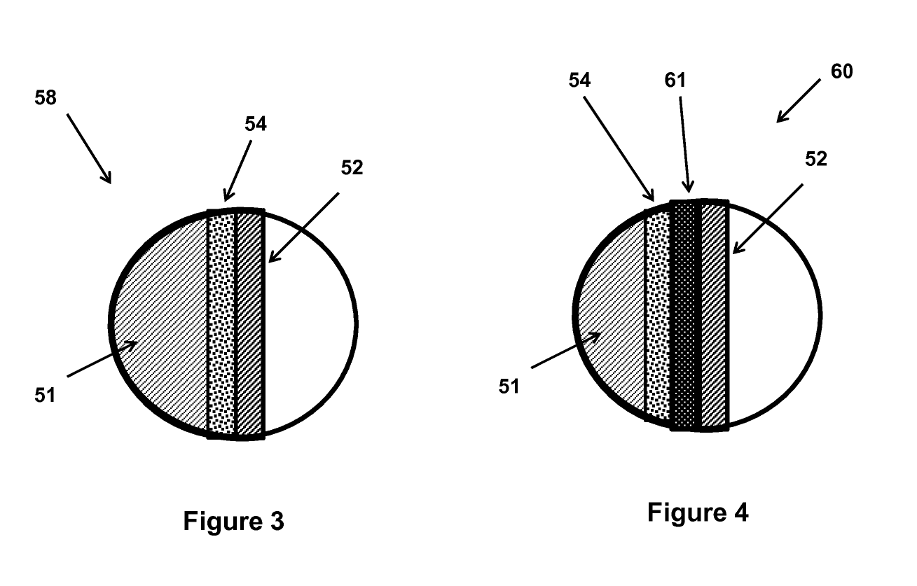

A close-up view 58 of the casing and insulation section 52 and 54, respectively, is shown in FIG. 3. A similar close-up view may also be considered for the cover 53 and its underlying the insulation section 55 and the following embodiments may also be employed in their construction. In the following embodiments, novel methods to construct different configurations of the insulation layer using the aforementioned silicon sponge and “porous silicon-based pyrotechnic” material 54, FIGS. 2 and 3, are disclosed. The advantages and possible shortcomings of each embodiment when used in different types and sizes of thermal batteries and/or their applications are also discussed.

A second embodiment is shown schematically in the close-up view 60 (as replacing the wall section close-up view 58 of the embodiment 50 shown in FIGS. 2 and 3) of FIG. 4. In the embodiment of FIG. 4, an insulation layer 61 (e.g., using any one of the currently available materials known in the prior art) is used between the casing 52 and the aforementioned “porous silicon-based pyrotechnic” material 54.

In operation, once the thermal battery is activated by igniting the heat generating elements of the thermal battery inside the element 51, FIGS. 2 and 4, the “porous silicon-based pyrotechnic” material 54 is also ignited as the consequence of the thermal battery activation via the heat generating elements of the battery or via separately provided pyrotechnic elements (not shown). Once the “porous silicon-based pyrotechnic” material 54 is ignited, as a result of at least partial silicon sponge material burning (oxidation), at least a portion of the silicon sponge material is converted to silica. As a result, firstly, heat is generated, which would have the beneficial effect of keeping the thermal battery operational longer or at least require lesser amounts of heat generating elements, thereby allowing the construction of relatively smaller thermal batteries that would stay operational the same length of time. Secondly, the conversion of the already substantially thermally insulating silicon sponge material to silica would generally increase its thermally insulating characteristics. As a result, the burning of the “porous silicon-based pyrotechnic” material 54 has the substantial effect of turning it into an effective thermal barrier while initially providing heat to the thermal battery core 51. The addition of the insulation layer 61 will ensure that the generated heat is not conducted out of the thermal battery casing 52.

It is noted that similar two-layer design (layers 61 and 54 in FIG. 4) may be used under the cover 53 (FIG. 2) to achieve the aforementioned effect.

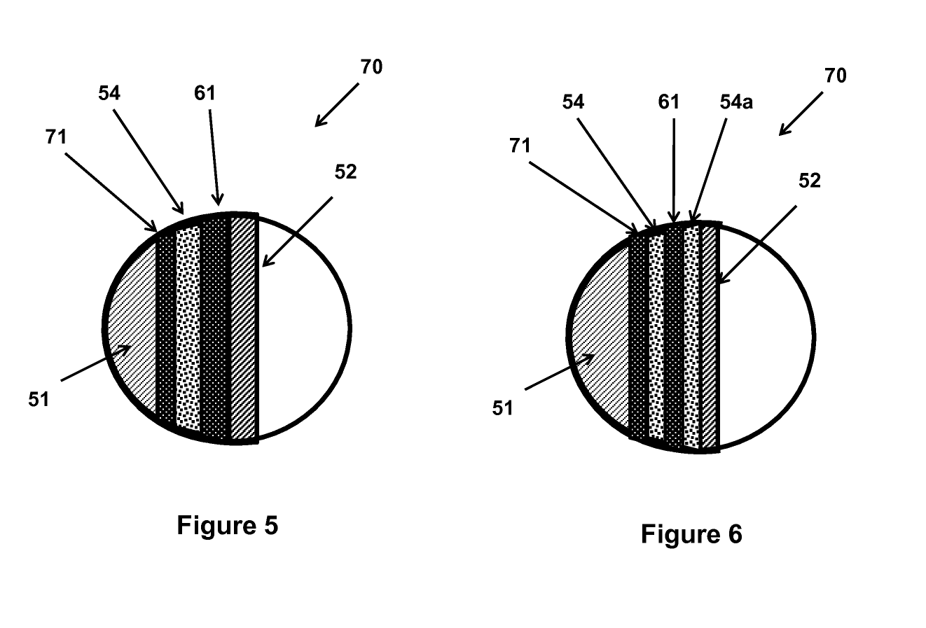

In a third embodiment 70, at least one insulation layer (e.g., using any one of the currently available materials known in the art) and at least one layer of aforementioned “porous silicon-based pyrotechnic” material is used between the aforementioned casing 52 (and possibly the cover 53) and the interior element 50 of the thermal battery (FIGS. 2 and 3). As an example, an additional layer of insulation 71 (using any one of the currently available materials known in the art) may be added to the embodiment of FIG. 4 between the “porous silicon-based pyrotechnic” material 54 and the interior element 51 as shown in the schematic of FIG. 5. The insulation layer 71 may be added to facilitate the packaging of the “porous silicon-based pyrotechnic” material 54, which may be in the form of “loose powder” without the use of added binders that could otherwise generate unwanted gasses.

In operation, once the thermal battery is activated by igniting the heat generating elements of the thermal battery inside the element 51, FIGS. 2 and 4, the “porous silicon-based pyrotechnic” material 54 may also be packaged to be ignited (e.g., by providing an opening in the insulation layer 71—not shown) as a consequence of the thermal battery activation via the heat generating elements of the battery. However, the “porous silicon-based pyrotechnic” material 54 is preferably ignited via separately provided pyrotechnic elements (not shown), possibly a certain period of time before or after the aforementioned thermal battery initiation depending on the design of the thermal battery and its operational requirements and the temperature of the environment to achieve optimal performance of the thermal battery. Once the “porous silicon-based pyrotechnic” material 54 is ignited, as a result of at least partial silicon sponge material burning (oxidation), at least a portion of the silicon sponge material is converted to silica. As a result, firstly, heat is generated, which would have the beneficial effect of keeping the thermal battery operational longer or at least require lesser amounts of heat generating elements, thereby allowing the construction of relatively smaller thermal batteries that would stay operational the same length of time. Secondly, the conversion of the already substantially thermally insulating silicon sponge material to silica would generally increase its thermally insulating characteristics. As a result, the burning of the “porous silicon-based pyrotechnic” material 54 has the substantial effect of turning it into an effective thermal barrier while initially providing heat to the thermal battery core 51. The addition of the insulation layer 61 will ensure that the generated heat is not conducted out of the thermal battery casing 52.

It is noted that similar multi-layer design (layers 61, 54 and 71 in FIG. 5) may be used under the cover 53 (FIG. 2) to achieve the aforementioned effect.

It will be appreciated by those skilled in the art that the embodiment 70 may be constructed with multi-insulation (e.g., using any one of the currently available materials known in the art) and the aforementioned “porous silicon-based pyrotechnic.” For example, one may use more than one sandwiched layers of insulation (e.g., using any one of the currently available materials known in the art) and “porous silicon-based pyrotechnic” materials to provide the means of generating heat by igniting the different “porous silicon-based pyrotechnic” layers sequentially to achieve optimal operational performance of the thermal battery by keeping the battery electrolyte at the desired temperature for a longer period of time.

It is also appreciated by those skilled in the art that neither the insulation material such as layers 61 and 71 in FIG. 5 (e.g., using any one of the currently available materials known in the art) nor the “porous silicon-based pyrotechnic” material layers such as 54 in FIG. 5, have to completely cover the entire side, bottom and/or the top surfaces of the thermal battery core 51. For example, “pockets” or “rings” of “porous silicon-based pyrotechnic” material can be provided within the insulation material layers 61 and/or 71 to localize their generated heat in those areas.

It will also be appreciated by those skilled in the art that any insulation material could be used for layers 61 and/or 71 in FIG. 5. For example, the layer 71 may be formed using the flexible fuel comprising at least one polymeric binding material and porous silicon particles dispersed throughout the polymeric binding material as disclosed in the U.S. Patent application 2009/0101251 of Subramanian, et al. filed on Apr. 23, 2009, the entire contents of which is incorporated herein by reference.

As shown in FIG. 6, two or more of the “porous silicon-based pyrotechnic” material layers 54, 54a can be provided with insulating layers 61, 71 disposed therebetween. In the configuration of FIG. 6, an additional insulting layer can be provided between the thermal battery casing 52 and the “porous silicon-based pyrotechnic” material layer 54a (as shown in FIG. 5).

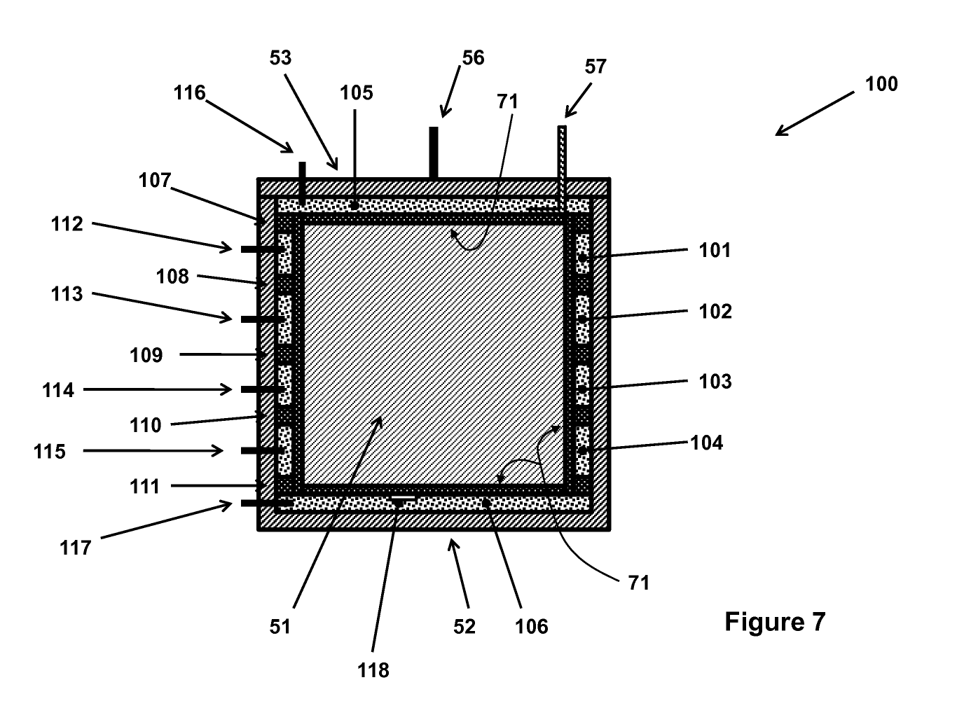

In another embodiment, the aforementioned two or more “porous silicon-based pyrotechnic” material layers (hereinafter also referred to as “active insulation” material), for example, the “porous silicon-based pyrotechnic” material layer 54 shown in the schematic of FIG. 5 or the “porous silicon-based pyrotechnic” material layers 54 and 54a shown in the schematic of FIG. 6 or when more “porous silicon-based pyrotechnic” material layers are employed, the “porous silicon-based pyrotechnic” material layers that are separated from the thermal battery core 51 by at least one insulation layer (such as the insulation layer 71 in the schematics of FIGS. 5 and 6) may be divided into separate compartments. Each one of these compartments are then separated from the other “porous silicon-based pyrotechnic” material filled compartments and layers and the thermal battery core by thermal insulation materials such as those used in the insulation layers 71, to prevent the initiation (burn) of the “porous silicon-based pyrotechnic” materials in one compartment or layer from initiating the burn of the “porous silicon-based pyrotechnic” materials in another compartment or layer. An example of such an embodiment 100 is shown schematically in FIG. 7.

In the schematic of FIG. 7 and for the sake of simplicity, the embodiment 100 is illustrated with only four individual “rings” of “porous silicon-based pyrotechnic” material filled compartments 101, 102, 103 and 104 and a top and bottom compartments 105 and 106, respectively. The porous silicon-based pyrotechnic” material filled compartments 101, 102, 103 and 104 are referred to as “rings” since FIG. 7 illustrates the thermal battery 100 in cross-section and the thermal battery is considered to be cylindrical (but can be of any shape). For the same reason, the thermal battery is considered to have only one “layer” of “porous silicon-based pyrotechnic” material, which is divided into the aforementioned six compartments (101, 102, 103, 104, 105 and 106). The “porous silicon-based pyrotechnic” material filled compartments 101, 102, 103, 104, 105 and 106 are separated by “bands” of thermal insulations made out materials such as material used for the insulation layer 71 (FIGS. 5 and 6), indicated by numerals 107, 108, 109, 110 and 111 in the schematic diagram of FIG. 7. The “porous silicon-based pyrotechnic” material filled compartments 101, 102, 103, 104, 105 and 106 are also each provided by initiation devices 112, 113, 114, 115, 116 and 117 (such as electrical initiation devices), respectively, so that they can be individually and independently initiated at any desired and appropriate time as described below to achieve optimal thermal battery performance.

In the schematic of the embodiment 100 illustrated in FIG. 7, the initiation devices 112, 113, 114, 115, 116 and 117 that are provided for the initiation of the “porous silicon-based pyrotechnic” material filled compartments 101, 102, 103, 104, 105 and 106, respectively, are shown to be inserted at various locations on the top cap 53 and side (casing) 52 of the thermal battery assembly. This positioning of the initiation devices is mainly for ease of illustration. In practice, however, the initiation devices 112, 113, 114, 115, 116 and 117 and their wiring can all be located inside of the thermal battery casing and are bundled and brought out for connection to the appropriate circuitry through the top cap 53 (or wherever the thermal battery leads 56 and 57 are routed out).

In the schematic of the embodiment 100 illustrated in FIG. 7, the aforementioned thermal battery core 51 is also enclosed in the appropriate casing 52 and cover 53, usually stainless steel and hermetically sealed. The thermal battery leads are indicated by numerals 56 and 57. The thermal battery core (activation) initiation device (such as the electrical initiation element 20 shown in the schematic of FIG. 1) is not shown in the schematic of FIG. 7 for clarity.

In operation, the thermal battery is activated by igniting the heat generating elements of the thermal battery core 51, FIG. 2, using the thermal battery activation initiator (not shown). As a result, the temperature of the thermal battery core 51 is increased and the solid electrolyte is melted, thereby enabling the thermal battery to provide electrical energy. In thermal batteries without the present “active insulation” material layer(s), the temperature of the thermal battery core will then begin to slowly decrease until the battery electrolyte begins to solidify, thereby rendering the thermal battery inactive. When the thermal battery core temperature nears its inactivation state, the provided “active insulation” material of the thermal battery can be initiated to provide heat to elevate the thermal battery core, thereby allowing the battery to stay active longer. When the aforementioned “porous silicon-based pyrotechnic” (active insulation) is used as the fuel and oxidizer mixture, following ignition of at least partial silicon sponge material, at least a portion of the silicon sponge material is converted to silica. As a result, firstly, heat is generated, which would have the beneficial effect of keeping the thermal battery operational longer or at least require lesser amounts of heat generating elements, thereby allowing the construction of relatively smaller thermal batteries that would stay operational the same length of time. Secondly, the conversion of the already substantially thermally insulating silicon sponge material to silica would generally increase its thermally insulating characteristics. As a result, the burning of the “porous silicon-based pyrotechnic” material also has the substantial effect of turning it into an effective thermal barrier while initially providing heat to the thermal battery core 51.

It is appreciated by those skilled in the art that at higher temperature levels, the thermal battery core would lose heat at higher rates. Thus, by allowing the added heat generated by the aforementioned “active insulation” material to be provided after the thermal battery core has cooled down to temperatures close to the inactivation temperature, the total amount of time that the thermal battery is going to stay active is increased. The embodiment 100 shown in the schematic of FIG. 7 provides the means for such heat generation as the thermal battery is cooled, while the aforementioned division of the provided fuel and oxidizer mixtures into individual pockets that can be independently initiated would provide the following added significant benefits:
It would not allow the aforementioned individual fuel and oxidizer mixtures to be initiated (burned) at any desired time following thermal battery activation. This provides the means of maximizing the thermal battery run time, i.e., the time duration during which the thermal battery is active and provides electrical energy to the system; and
It provides the opportunity to provide heat as needed to the regions of the activated thermal battery that has cooled to close to the electrolyte solidification temperature (i.e., thermal battery deactivation). In such embodiments, the thermal battery core temperature at its difference surface areas are measured to identify those regions at/around which the fuel and oxidizer mixture pocket should be initiated. In general, the thermal battery voltage and current (power) levels that can be provided can be used as an indication of the thermal battery core temperature. However, for the aforementioned heating by local fuel and oxidizer mixture pockets, the thermal battery core surface temperature needs to be measured at as many areas as practical to determine which fuel and oxidizer mixture pocket to be initiated to achieve optimal thermal battery performance, i.e., the maximum thermal battery run (activation) time.

It will be appreciated by those skilled in the art that as the thermal battery core is cooled, the coldest regions of the thermal battery core will always be on its exterior surfaces. Thus, to determine the location (regions) of lowest thermal battery core temperatures, one would only need to monitor the thermal battery core surfaces.

In a variation of the embodiment of FIG. 7, temperature sensors such as 118 shown in the schematic of FIG. 7 are distributed over the surface of the thermal battery core 51, preferably behind the insulation layer 71 that covers the surface of the thermal battery core (in the schematic of FIG. 7 only one such temperature sensor 118 is shown for the sake of clarity, however, a plurality of the temperature sensors 118 can be provided at various positions). Such temperature sensors are generally required to be capable of measuring temperatures of up to around 500 degrees C., and are well known in the art, such as those based on thermocouples or changes in the resistance of electrical resistor elements. It will be appreciated by those skilled in the art that in general, only a few such temperature sensors are generally required for the purpose of determining at which location additional heat is to be provided to keep the thermal battery core activated, i.e., to keep the thermal battery electrolyte molten and above certain temperature. This is generally the case since by performing thermal modeling of the thermal battery, one can predict the cooling pattern of the thermal battery core and thereby ensure that the aforementioned temperature sensors are strategically positioned to detect temperature of these regions of the thermal battery core. When a cooler region (a region in which additional heat is determined necessary in order to keep the thermal battery electrolyte molten and above a certain predetermined temperature) is detected, a corresponding portion of porous silicon-based pyrotechnic material 101, 101, 103, 104, 105, 106 and 107 can be initiated with a corresponding initiation device 112, 113, 114, 115, 116 and 117.

In addition and/or in place of one or more of the temperature sensors 118, the electrical initiators 112-117 are used to serve as temperature sensors before their activation to ignite the corresponding fuel and oxidizer mixture pockets. Most current electrical initiators are constructed as low resistance filaments (wires) that are heated by supplied current to initiate pyrotechnic materials. The actual resistance of such filaments is dependent on their temperature, and can therefore be used as temperature sensor by monitoring their electrical resistance. The advantages of using the electrical initiators as temperature sensors are that firstly the need for at least some of the temperature sensors is eliminated, and secondly, when a drop in the power produced by the thermal battery is detected and/or when thermal battery core temperature is detected to be closing to its inactivation temperature, then the fuel and oxidizer pocket(s) at which their electrical initiators show lowest temperatures, need only be initiated, noting that the actual temperature values are not required to determine which fuel and oxidizer mixture needs to be initiated.

In another embodiment, particularly for smaller thermal batteries, one may only need to formulate a thermal model for the thermal battery core cooling following the battery activation and determine the sequence with which the fuel and oxidizer mixture pockets need to be initiated.

In the embodiment 100 of FIG. 7, only one layer of fuel and oxidizer mixture is used for the purpose of illustration. It will be, however, appreciated by those skilled in the art that more than one such layer, divided in a number of individual pockets of various shapes (not all “ring type” as shown in the schematic of FIG. 7) may also be used and provided with initiation devices to ignite individually or as groups of two or more. In fact, in certain applications where the thermal battery is not cylindrically shaped or has varying cross-sectional shapes, fuel and oxidizer mixture pockets of various shapes and sizes may be provided at various positions around the thermal battery core so that through their ignition at proper times the thermal battery core temperature could be kept above the battery inactivation temperature, thereby maximizing the thermal battery runtime. As a result, thermal batteries with relatively long runtime having a non-cylindrical shape or varying cross-section to match the available space in munitions can be effectively developed.

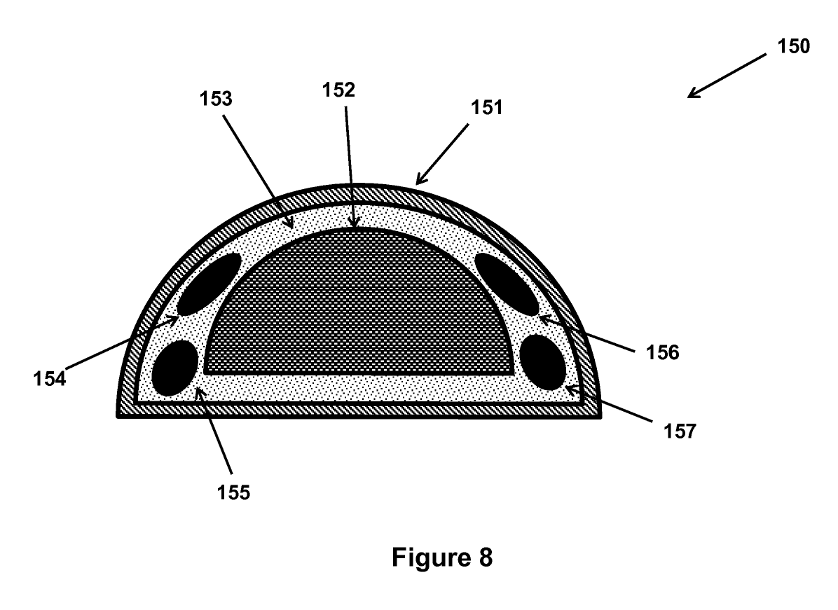

As an example, consider the embodiment 150, a thermal battery with a “D-shaped” cross-section as shown in the schematic of FIG. 8. The thermal battery 150 is constructed with the housing 151, preferably made out of stainless steel, which houses the thermal battery core 152. The space between the housing 151 and the thermal battery core is considered to be filled with an insulation material 153. Pockets 154, 155, 156 and 157 of fuel and oxidizer mixture are distributed around the thermal battery core as shown in the schematic of FIG. 8, where the thermal battery core would tend to cool faster due to being further away from the center of the thermal battery core. The fuel and oxidizer pockets 154, 155, 156 and 157 are provided with individual (preferably electrical) initiators as shown in the schematic of FIG. 7 or two or more are grouped together and each group is provided with an initiator (not shown in the schematic of FIG. 8). Then when the thermal battery is activated and the thermal battery core begins to cool and its certain regions begin to cool down to close to the inactivation temperature of the thermal battery core, one or more of the fuel and oxidizer pockets 154, 155, 156 and 157 can be initiated to heat said region of the thermal battery and keep the battery activated. As a result, the runtime of such irregularly shaped thermal batteries can be significantly increased.

In general, the cooling pattern of thermal batteries of various shapes and those with thermal battery cores of irregular shapes can be readily and closely determined through widely available computer modeling software and simulation of their transient thermal response following activation. Such cooling patterns can then be used to determine the optimal shape of the thermal battery core, insulation material and optimal size, shape and distribution of the fuel and oxidizer mixture filled pockets to achieve maximum battery runtime.

In the embodiment 150 of FIG. 8, only one layer of thermal insulation material and only four pockets of fuel and oxidizer mixture are shown for the purpose of illustration. It will be appreciated by those skilled in the art that in practice, more than one layer of insulation material and more or less pockets of fuel and oxidizer mixture of various appropriate shapes and sizes may be used to achieve optimal thermal battery performance, including runtime and minimal total size to fit the available space in munitions.

In another variation, that part of the surfaces of the cell core can be covered with the exothermic material as discussed above and another part of the surfaces of the cell core can be covered with commonly used thermal insulation material. This variation is particularly suitable when the shape of the thermal battery is such that certain regions cools faster than the others, for example, the sides of the “D-shaped” design in FIG. 8.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method of producing power from a thermal battery, the method comprising:
initiating a core of the thermal battery; and
initiating at least one portion of a material having an exothermic reaction positioned outside the core when a temperature of at least a portion of the core falls below a predetermined level.

2. The method of claim 1, wherein the initiating of the at least one portion comprises monitoring the temperature of the core corresponding to the at least one portion.

3. The method of claim 2, wherein the monitoring comprises determining the temperature of the core based on an output of a sensor.

4. The method of claim 2, wherein the monitoring comprises determining the temperature of the core based on an output of the thermal battery.

5. The method of claim 1, wherein the at least one portion comprises a plurality of portions.

6. The method of claim 5, wherein the initiating of the plurality of portions comprises monitoring the temperature of the core corresponding to each of the plurality of portions, wherein only those portions of the plurality of portions in which the corresponding core has a temperature determined to be below the predetermined level are initiated.

7. The method of claim 1, wherein the predetermined temperature is an inactivation temperature of the thermal battery.

8. The method of claim 1, wherein a product of the exothermic reaction of the at least one portion is a thermal insulator.

9. A method of producing power from a thermal battery, the method comprising:
initiating a core of the thermal battery;
positioning at least one portion of a material having an exothermic reaction positioned outside the core;
monitoring a temperature of the core corresponding to the at least one portion; and
initiating the at least one portion when the temperature of the core corresponding to the at least one portion falls below a predetermined level.

10. The method of claim 9, wherein the positioning of the at least one portion comprises positioning a plurality of portions of the material having an exothermic reaction positioned outside the core.

11. The method of claim 10, wherein the monitoring comprises monitoring the temperature of the core corresponding to each of the plurality of portions, wherein only those portions of the plurality of portions in which the corresponding core has a temperature determined to be below the predetermined level are initiated.

12. The method of claim 10, wherein the positioning of the plurality of portions is based on a thermal modeling of the thermal battery.

13. The method of claim 9, wherein the predetermined temperature is an inactivation temperature of the thermal battery.

14. The method of claim 9, wherein the monitoring comprises determining the temperature of the core based on an output of a sensor.

15. The method of claim 14, wherein the monitoring and initiating of the at least one portion are provided by an initiation device.

16. The method of claim 9, wherein the monitoring comprises determining the temperature of the core based on an output of the thermal battery.

17. The method of claim 9, wherein a product of the exothermic reaction of the at least one portion is a thermal insulator.

18. A thermal battery comprising:
a casing;
a thermal battery cell disposed in the casing and operatively connected to electrical connections exposed from the casing;
at least one portion of a material having an exothermic reaction positioned between the casing and the thermal battery cell;
a first initiator for initiating the thermal battery cell;
at least one second initiator for initiating the at least one portion; and
a temperature sensor for monitoring a temperature of the thermal battery cell corresponding to the at least one portion;
wherein the second initiator initiates the at least one portion when the temperature of the thermal battery cell corresponding to the at least one portion falls below a predetermined level.

19. The thermal battery of claim 18, wherein the at least one portion comprises a fuel and oxidizer mixture.

20. The thermal battery of claim 19, wherein the fuel and oxidizer mixture comprise silicon nanosponge particles and porous silicon particles.

21. The thermal battery of claim 18, wherein the thermal battery cell is selected from a list consisting of perchlorates, nitrates, permanganates, fluorinated polymers and metal oxides

22. The thermal battery of claim 18, wherein the at least one portion comprises a plurality of portions of the material having an exothermic reaction positioned between the casing and the thermal battery cell.

23. The thermal battery of claim 22, wherein the temperature sensor comprises a plurality of temperature sensors, each corresponding to one of the plurality of portions, wherein only those portions of the plurality of portions in which the corresponding thermal battery cell has a temperature determined to be below the predetermined level are initiated.

24. The thermal battery of claim 18, wherein the temperature sensor comprises the at least one second initiator.

25. The thermal battery of claim 22, further comprising insulator portions disposed between the plurality of portions.

26. The thermal battery of claim 18, wherein the casing is cylindrical.

27. The thermal battery of claim 22, wherein the plurality of portions are distributed in a pattern based on a computer simulation of the thermal battery cell.

28. The thermal battery of claim 18, wherein a product of the exothermic reaction of the at least one portion is a thermal insulator.
